(19) United States
(12) Patent Application Publication
(10) Pub. No.: US 2022/0234140 A1
(43) Pub. Date: Jul. 28, 2022

(54) METHOD FOR PROCESSING A LITHIUM FOIL OR A LITHIUM-COATED METAL FOIL BY A LASER BEAM

(71) Applicant: TRUMPF Laser- und Systemtechnik GmbH, Ditzingen (DE)

(72) Inventor: Oliver Bocksrocker, Sachsenheim (DE)

(21) Appl. No.: 17/719,461

(22) Filed: Apr. 13, 2022

Related U.S. Application Data
(63) Continuation of application No. PCT/EP2020/079276, filed on Oct. 16, 2020.

(30) Foreign Application Priority Data
Oct. 18, 2019 (DE) 10 2019 216 070.0

(51) Int. Cl. B23K 26/322; B23K 26/382; B23K 26/24; B23K 26/40

(52) U.S. Cl. CPC B23K 26/322; B23K 26/382; B23K 2101/36; B23K 26/40; B23K 26/24

(57) ABSTRACT

A method for processing a foil comprising lithium includes irradiating the foil with a laser beam having a wavelength of between 200 nm and 1 μm.

### CROSS REFERENCE TO RELATED APPLICATIONS

This application is a continuation of International Application No. PCT/EP2020/079276 (WO 2021/074424 A1), filed on Oct. 16, 2020, and claims benefit to German Patent Application No. DE 10 2019 216 070.0, filed on Oct. 18, 2019. The aforementioned applications are hereby incorporated by reference herein.

### FIELD

Embodiments of the present invention relate to a method for processing a foil comprising lithium by a laser beam.

### BACKGROUND

For the production of solid-state batteries, plain lithium foils or lithium-coated copper or aluminum foils are used as electrode foils, in particular as an anode. In this case, the foils are processed, for example cut to size, welded, drilled, ablated or surface-structured, by means of a laser beam with an NIR wavelength in the range of 1000 to 1100 nm, in particular 1030 nm. This laser processing causes adverse effects because of a large-area heat affected zone and because of adhesive attachment of melt and particles at or near the processing zone of the foil. The heat affected zone can cause increased occurrence of lithium hydroxide due to reaction with water from the ambient air. Melt and particle attachment can lead to the foil being destroyed.

### SUMMARY

Embodiments of the present provide a method for processing a foil comprising lithium. The method includes irradiating the foil with a laser beam having a wavelength of between 200 nm and 1μm.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIGS. 1a, 1b schematically show the processing of a plain lithium foil (FIG. 1a) and a lithium-coated foil (FIG. 1b) by means of a laser beam;

FIG. 2 shows the absorbance of lithium metal in dependence on the angle of incidence for wavelengths in the NIR, green, blue and UV ranges; and

FIGS. 3a-3e schematically show various examples of applications of the processing of a foil comprising lithium.

### DETAILED DESCRIPTION

Embodiments of the present invention can reduce or avoid the disadvantages in the aforementioned conventional methods.

Embodiments of the present invention uses a laser beam having a wavelength of between 200 nm and 1μm. In this wavelength range, the absorbance of lithium both for s-polarized and for p-polarized light is about 3 to 10 times greater than the absorbance for the previously mostly used NIR wavelength of 1030 nm. The higher absorption according to the invention allows higher production feeds to be achieved with the same laser power and intensity. This results in a reduced heat affected zone, whereby less lithium hydroxide occurs. Moreover, because of the higher absorption, fewer instances of melt and particle attachment are induced at the cutting edge, which results in less wastage.

Preferably used as the foil is a plain lithium foil or a metal foil, in particular a copper or aluminum foil, coated with lithium. Such foils are preferably used as an electrode, in particular an anode, in the production of solid-state batteries.

In an embodiment, the wavelength of the laser beam lies in the green range between 500 nm and 550 nm, in particular at about 515 nm. In this wavelength range, the absorption under perpendicular incidence of light is greater by a factor of up to about 2.8 in comparison with NIR laser light (1030 nm). The green wavelengths can be generated without any problem, for example with a disk laser.

In another embodiment, the wavelength of the laser beam lies in the blue range between 440 nm and 460 nm, in particular at about 450 nm, or in the violet range between 400 nm and 410 nm, in particular at about 405 nm. In these wavelength ranges, the absorption under perpendicular incidence of light is greater by a factor of up to about 4.7 in comparison with NIR laser light (1030 nm). The blue and violet wavelengths can be generated without any problem, for example with a diode laser.

In yet another embodiment, the wavelength of the laser beam lies in the UV range between 250 nm and 370 nm, in particular at about 257 nm, at about 355 nm or at about 342 nm. In this wavelength range, the absorption under perpendicular incidence of light is greater by a factor of up to about 10.6 in comparison with NIR laser light (1030 nm). The UV wavelengths can be generated without any problem, for example with a disk laser.

According to embodiments of the present invention, the foil comprising lithium may be cut, welded, recessed or drilled, ablated or surface-structured by means of the laser beam.

In some embodiments, the laser beam impinges on the surface of the foil at an angle of incidence of between 0° and about 45° , preferably between 0° and 30°.

Further advantages and advantageous refinements of the subject matter of the invention are evident from the description, the claims and the drawing. Similarly, the features mentioned above and those still to be further presented can be used in each case individually or together in any desired combinations. The embodiments shown and described should not be understood as an exhaustive enumeration, but rather are of exemplary character for outlining the invention.

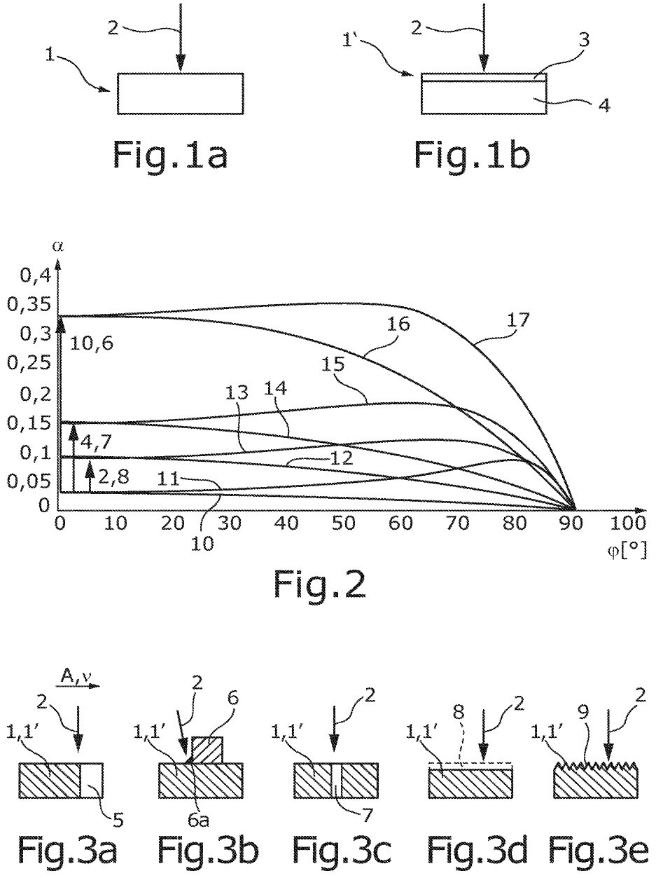

The method according to the invention serves for processing a foil 1 comprising lithium by means of a laser beam 2, i.e. the foil 1 consists at least partially of lithium. As shown in FIG. 1a, the foil 1 may be for example a plain lithium foil or, as shown in Fig. 1b, a metal foil 4 coated with lithium 3, for example an aluminum or copper foil coated with lithium 3. Preferably, the foil 1, 1′ has a thickness of 10 μm to 400 μm, advantageously of about 20 μm. The processing of the foil 1, 1′ takes place in particular with the aim of using the foil 1, 1′ as an electrode, in particular an anode, of a solid-state battery.

The laser processing of such foils 1, 1′ has previously been performed by means of laser radiation in the NIR range with wavelengths of 1000-1100 nm, in particular with a wavelength of 1030 nm. However, this laser processing causes adverse effects because of a large-area heat affected zone and because of adhesive attachment of melt and particles at or near the processing zone. The heat affected zone can cause increased occurrence of lithium hydroxide due to reaction with water from the ambient air and melt and particle attachment can lead to the foil 1, 1′ being destroyed.

FIG. 2 shows absorption curves (Fresnel) of lithium metal in dependence on angles of incidence for wavelengths in the NIR, green, blue and UV ranges at a temperature of the lithium metal of 298° K. The absorbance a is plotted against the angle of incidence φ for the s-polarized and p-polarized components of the incident light—respectively for an NIR, a green, a blue and a UV wavelength—, the s-polarized component being linearly polarized perpendicularly to the plane of incidence and the p-polarized component being linearly polarized parallel to the plane of incidence.

The absorption curves 10, 11 show the absorbance of the s-polarized and p-polarized components of currently used NIR laser light with a wavelength of 1030 nm. The absorbances achieved under perpendicular incidence of light)(φ=0°) are around 0.03 and only allow low feed rates (“feeds”) in the foil processing for introducing into the foil 1, 1′ the energy required for the processing.

The absorption curves 12, 13 show the absorbance of the s-polarized and p-polarized components of green laser light with a wavelength of 515 nm. It can be seen that, under perpendicular incidence of light)(φ=0°), the absorbance of green laser light is around 0.09, and consequently is greater by a factor of about 2.8 in comparison with NIR laser light (absorption curves 10, 11).

The absorption curves 14, 15 show the absorbance of the s-polarized and p-polarized components of blue laser light with a wavelength of 450 nm. It can be seen that, under perpendicular incidence of light)(φ=0° , the absorbance of blue or violet laser light is around 0.15, and consequently is greater by a factor of about 4.7 in comparison with NIR laser light (absorption curves 10, 11).

The absorption curves 16, 17 finally show the absorbance of the s-polarized and p-polarized components of ultraviolet laser light with a wavelength of 342 nm. It can be seen that, under perpendicular incidence of light)(φ=0° , the absorbance of ultraviolet laser light is around 0.33, and consequently is greater by a factor of about 10.6 in comparison with NIR laser light.

Instead of as previously by means of a laser beam in the NIR range, according to the invention the laser processing of the foils 1, 1′ is performed by means of a laser beam 2 in the green range between 500 nm and 550 nm, in particular at about 515 nm, in the blue range between 440 nm and 460 nm, in particular at about 450 nm, in the violet range between 400 nm and 410 nm, in particular at about 405 nm, or in the UV range between 250 nm and 370 nm, in particular at about 257 nm, at about 355 nm or at about 342 nm. For all of these wavelength ranges, the absorbance is increased by a factor of about 2.8 to 10.6 in comparison with NIR laser light, whereby higher production feeds are achieved with the same laser power and intensity. This results in a reduced heat affected zone, whereby less lithium hydroxide occurs. Moreover, because of the higher absorption, fewer instances of melt and particle attachment are induced at the cutting edge, which results in less wastage.

A cw laser beam or a pulsed laser beam may be used as the laser beam 2. As tests have shown, the laser power used should in this case be between 100 W and 4000 W, in particular about 1000 W, and the spot diameter of the laser beam 2 on the foil 1, 1′ should be between 50 μm and 600 μm, in particular about 85 μm. In the case of a pulsed laser beam 2, the pulse durations may be between 0.2 ms and 50 ms. In the course of the processing, the laser beam 2 is moved over the foil 1, 1′, it being possible for the feeds that can be achieved thereby to lie in the range from 50 to 5000 mm/s. A scanner optical unit may be used for the processing and a camera-based sensor system may be used for the positioning.

FIGS. 3a-3e show various examples of applications of the processing of a foil 1, 1′ comprising lithium by means of a laser beam 2 with green, blue, violet and UV wavelengths.

In FIG. 3a, the foil 1, 1′ is cut by means of the green, blue, violet or UV laser beam 2 in order to produce a cut-to-size foil blank suitable for the production of solid-state batteries. This involves the laser beam 2 being moved in the feeding direction A at the feed rate or cutting speed v over the foil 1, 1′ in order to produce a cut 5. The high absorption of the green, blue, violet or UV laser beam 2 has the effect that more material is vaporized than with a conventional NIR laser beam (1030 nm), and the adhesive attachment of melt is reduced.

In FIG. 3b, a metallic current collector 6 is welded onto the foil 1, 1′ in an electrically conducting manner by means of the green, blue, violet or UV laser beam. The weld seam is denoted by 6a. For the case where the foil 1, 1′ forms the anode in a solid-state battery, the current collector 6 serves for carrying the current away to the outside. The current collectors 6 generally consist of a different metal than the anode of the solid-state battery.

FIG. 3c shows a hole or recess 7 drilled into the foil 1, 1′ by means of the green, blue, violet or UV laser beam 2. Such holes 7 in the foil 1,1′ can serve in the production of solid-state batteries for mechanically connecting a number of layers of foils 1,1′ to one another.

In the case of the foil 1, 1′ shown in FIG. 3d , one or more layers 8 of the surface have been ablated by means of the green, blue, violet or UV laser beam 2. In the case of the foil 1′, that is to say a metal foil 4 coated with lithium 3, for example the entire lithium coating can thus be ablated (removed) specifically in a desired region.

FIG. 3e shows the foil 1, 1′ with a structured surface 9, the surface structure having been produced by irradiating the surface of the foil with the green, blue, violet or UV laser beam 2.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for processing a foil comprising lithium, the method comprising:
irradiating the foil with a laser beam having a wavelength of between 200 nm and 1 μm.

2. The method as claimed in claim 1, wherein the foil is a lithium foil or a metal foil coated with lithium.

3. The method as claimed in claim 2, wherein the metal foil comprises a copper foil or an aluminum foil coated with lithium.

4. The method as claimed in claim 1, wherein the wavelength of the laser beam lies in the green range between 500 nm and 550 nm.

5. The method as claimed in claim 4, wherein the wavelength of the laser beam is about 515 nm.

6. The method as claimed in claim 1, wherein the wavelength of the laser beam lies in the blue range between 440 nm and 460 nm.

7. The method as claimed in claim 1, wherein the wavelength of the laser beam lies in the violet range between 400 nm and 410 nm.

8. The method as claimed in claim 1, wherein the wavelength of the laser beam lies in the UV range between 250 nm and 370 nm.

9. The method as claimed in claim 8, wherein the wavelength of the laser beam is about 257 nm, or about 355 nm, or about 342 nm.

10. The method as claimed in claim 1, wherein the foil is cut by the laser beam.

11. The method as claimed in claim 1, wherein the foil is welded by the laser beam.

12. The method as claimed in claim 1, wherein a hole or a recess is drilled into the foil by the laser beam.

13. The method as claimed in claim 1, wherein material is ablated from a surface of the foil by the laser beam.

14. The method as claimed in claim 13, wherein the surface of the foil is structured by the laser beam.

15. The method as claimed in claim 1, wherein the laser beam impinges on a surface of the foil at an angle of incidence of between 0° and about 45°.

16. The method as claimed in claim 15, wherein the angle of incidence is between 0° and 30°.
